(19) United States
(12) Patent Application Publication
(10) Pub. No.: US 2017/0238580 A1
(43) Pub. Date: Aug. 24, 2017

(54) SYSTEM AND PROCESS FOR DESTROYING C. BOTULINUM SPORES IN PRESSED BEVERAGE USING THERMAL PASCALIZATION

(71) Applicant: Pressed Juicery, LLC, Santa Monica, CA (US)

(72) Inventors: Malcolm Knight, Calabasas, CA (US); Jillian Elaine Costelow, Clovis, CA (US)

(21) Appl. No.: 15/588,528

(22) Filed: May 5, 2017

Related U.S. Application Data
(63) Continuation-in-part of application No. 14/936,603, filed on Nov. 9, 2015.
(60) Provisional application No. 62/078,395, filed on Nov. 11, 2014.

(51) Int. Cl. A23L 2/46; A23L 2/38; A23L 3/22; A23L 2/02

(52) U.S. Cl. CPC A23L 2/46; A23L 2/02; A23L 2/38; A23L 3/22; A23V 2002/00

(57) ABSTRACT

A system and process for destroying C. Botulinum spores in ready to drink beverages is presented. The system includes a product tank receives ready to drink beverage. The product tank is fluidly coupled to a first heat exchanger for heating the beverage to a kill temperature using a closed loop counter current process. The heated beverage is passed through one or more hold tubes to maintain the kill temperature for a minimum hold time resulting in thermally pasteurizing the beverage. The thermally pasteurized beverage is passed through a second heat exchanger for cooling the beverage down to a desired packaging temperature using a closed loop counter current process. The cooled beverage is then placed in a feed tank ready for packaging. A distribution container is filled with the cooled beverage from the feed tank and the container is sealed. The sealed distribution container is then subjected to high pressure processing.

### CROSS-REFERENCE TO RELATED APPLICATIONS

The present application is a continuation-in-part of U.S. patent application Ser. No. 14/936,603, filed on Nov. 9, 2015, which claims the benefit of U.S. Provisional Application Ser. No. 62/078,395, filed on Nov. 11, 2014, specifications of which are herein incorporated by reference for completeness of disclosure.

### BACKGROUND OF THE INVENTION

Field of the Invention

Embodiments of the invention relates to the field of bacteria control in beverages. More specifically, the invention relates to method and apparatus for destroying C. Botulinum spores in ready to drink beverages.

Description of the Related Art

There are currently no known systems for destroying Clostridium botulinum (C. botulinum) spores in ready-to-drink (RTD) chilled pressed juices and beverages while maintaining flavor profile of the product.

In the past, the pertinent organisms of concern for ready to drink refrigerated juices were Listeria monocytogenes, Escherichia coli O157:H7, and Salmonella. Thus, prior art methods for controlling and destroying these pathogens were primarily through High Pressure Processing (HPP) of the refrigerated product. However, HPP does not impact C. botulinum spores. Historically, a 6D or 12D kill process is required; however, a 12D process would completely ruin the RTD chilled pressed juices and beverages.

However, the United States Food and Drug Administration (FDA) recently determined that the most resistant microorganism of public health concern for a pasteurization process for ready-to-drink juices is Clostridium botulinum spores even if these products are refrigerated at the optimum storage temperature is ≦5° C. (41° F.), which is supposed to eliminate the possibility of microbial growth. However, since as much as 10% of product temperatures in consumer refrigerators in the United States are above 7.2° C. (45° F.), and because of recent incidences of C. botulinum outbreak, the FDA now defines the pertinent organism of concern for products with pH >4.6 to be C. botulinum spores at 1.5 times the shelf life of the product at ambient temperatures, even if it's a refrigerated product.

Spore-forming bacteria such as C. botulinum (non-proteolytic type B), which might cause outbreaks in low-acid under-pasteurized foods, exhibited the highest heat resistance (highest D-values). This means that a temperature of less than 85° C. (185° F.) is not adequate to yield even a one-log reduction after several minutes of processing time.

The pasteurization of juice is regulated by the FDA regulation 21 CFR 120, Hazard Analysis and Critical Control Point (HACCP) systems (CFR, 2011). A process with at least 6-log (i.e. 6D) reduction of the most resistant microorganism of public health significance identified as the pertinent pathogen under HACCP plan is required for low-acid juices (pH >4.6) wherein C. botulinum may be present and produce toxins, and therefore become the pathogen hazard of concern.

### BRIEF SUMMARY OF THE INVENTION

One or more embodiments of the invention are directed a process and apparatus for destroying C. botulinum spores in ready to drink beverages using thermal pascalization. The thermal pascalization of the present invention comprises thermal pasteurization and high pressure processing (i.e. pascalization) of cold pressed or extracted beverages.

One or more embodiments of the invention begins with a method for extracting ready to drink beverages from produce. The method is generally directed to a process that involves receiving and handling of produce; sorting and trimming the produce; weighing and batching the produce; disinfection/sanitization of the produce; extraction of beverage from the produce; filtration of beverage; mixing/blending of beverage; and packaging of the final beverage product for distribution.

In one or more embodiments, the juice extraction assembly comprises a receiving station for produce. The process of receiving and handling is the initial step and generally involves receiving and maintaining the produce in the state in which it was received. For instance, refrigerated produce is received and maintained in the refrigerated state; frozen produce is received and maintained in the frozen state; and dry goods are received and maintained at ambient temperatures.

In one or more embodiments, the juice extraction assembly comprises a sorting station. The sorting and trimming step is performed to ensure the produced beverage meets specific quality specifications. Depending on the flavor profile of the beverage, the produce may receive different preparations. For example, the rind is separated from the meat for Classic watermelon. However, for other watermelon beverages, the whole watermelon rind and meat may be juiced.

One or more embodiments of the present invention further comprise a disinfection station. The disinfection station is preferably a cold refrigerated environment. During this step, the produce may be sanitized using traditional PAA (Peracetic acid) methods and then placed into a grinder directly above the cold press.

One or more embodiments of the present invention further comprise a feedstock station wherein the weighing and batching of the produce is performed. The weighing and batching step provides a starting estimated produce weight based on expected yield of raw produce for the extracted beverage. However, the juice extraction process continues to run with additional feedstock until the expected yield of juice needed for the juice blends is obtained. Preferably, each individual produce is juiced separately and then combined as needed to make juice blends, i.e. the desired beverage.

One or more embodiments of the present invention further comprise a juice extraction station. The juice extraction station is preferably a cold refrigerated environment. The juice extraction station comprises a produce grinder as the cold press. The produce grinder is preferably a high pressure screw type device, e.g., the CP and KP series screw presses from Vincent Corporation. One or more embodiments comprise stainless steel single screw and twin screw system with a large-hole screen sized to separate the juice from the pulp under pressure. The process is a continuous feed system compared to prior art systems that use a batch accordion style bag press system.

Citrus produce can be either cold pressed or cold extracted. Traditional juice extractors that are typical in the industry for pasteurized juice may be used for cold extraction.

One or more embodiments of the present invention further comprise a filtering station. The filtering station comprises a vibratory filter system that uses various size mesh screens to filter the juice using gravity and/or pressure. The filtering station comprises a gentle filtering process that minimizes off flavor profiles from high pressure on the juice pulp. Depending on the desired clarity of the final beverage product, the juice may also be processed through a mesh sock filter.

One or more embodiments of the present invention further comprise a mixing/blending station. At the mixing/blending station, juices may be mixed together based on a formula. The mixed juices may be tasted and adjusted to match certain flavor profile by adding small amounts of juices and ingredients as needed. Master Tasters may be used to make final decisions on juice profiles.

One or more embodiments of the present invention further comprise a thermal pasteurization process. The cold pressed beverage with pH >4.6, e.g. fruit/vegetable juices or nut milks, from the cold pressing process is transferred to a thermal pasteurization process station.

The system for thermal pasteurization is sterilized with a proprietary hot water sterilization process using acidified water at the same pH level as the pressed beverage. The system preferably holds the sterilization temperature for a minimum period of time to meet sterilization requirements. In one or more embodiments, the sterilized system circulates on sterile water waiting on the raw product.

The pressed/extracted beverage, or raw product, from the blending and mixing station enters the thermal process through a product tank. The beverage product is heated in a closed loop plate heat exchanger to a kill temperature. The beverage product, which is at approximately the kill temperature, exits the heat exchanger and enters a two-part hold tube or fluid temperature hold conduit (FTHC), to hold the beverage product at approximately the kill temperature for a minimum hold time. This process provides for a thermal process approved by the FDA for pH >4.6 products with the pertinent organism C. Botulinum spores. The thermal pasteurization process of the present invention utilizes a process temperature below 205° F., which is a gentler process that does not impact proteins and flavor profile of the beverage products. A process temperature above 210° F. renders the product to have a cooked flavor profile, as confirmed with sensory testing.

In one or more embodiments, the thermally processed beverage product is then cooled down in a closed loop system and transferred to the filler feed tank for filling purposes. After the beverage product is filled and sealed in an appropriate packaging container, the refrigerated sealed container then undergoes high pressure processing (i.e., Pascalization) to complete the Pressed Thermic Pascalization process of the present invention.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of an exemplary juice extraction process flow for refrigerated goods in accordance with one or more embodiments of the present invention.

FIG. 2 is an illustration of an exemplary Bulk Bag packaging process in accordance with one or more embodiments of the present invention.

FIG. 3 is an illustration of an exemplary freeze process flow for frozen goods in accordance with one or more embodiments of the present invention.

FIG. 4 is an illustration of an exemplary dry goods extraction process in accordance with one or more embodiments of the present invention.

FIG. 5 is an illustration of an exemplary CP Series Screw Press from Vincent

Corporation employed in one or more embodiments of the present invention.

FIG. 6 is an illustration of an exemplary KP Series Screw Press from Vincent

Corporation employed in one or more embodiments of the present invention.

FIG. 7 is an illustration of an exemplary Batch Mixer employed in one or more embodiments of the present invention.

FIG. 8 is an illustration of an exemplary hybrid produce extraction process in accordance with one or more embodiments of the present invention.

FIG. 9 is an illustration of an exemplary thermal processing component of the Pressed Thermic Pascalization system in accordance with one or more embodiments of the present invention.

FIG. 10 illustrates a general-purpose computer and peripherals that when programmed as described herein may operate as a specially programmed computer in accordance with one or more embodiments of the present invention.

### DETAILED DESCRIPTION

The present invention comprising apparatus and process for destroying C. botulinum spores in ready to drink chilled pressed juices and beverages using thermal pascalization will now be described. The process and system of the present invention comprising thermal processing, packaging and high pressure processing will be referred herein as “Pressed Thermic Pascalization” or (PTP). In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

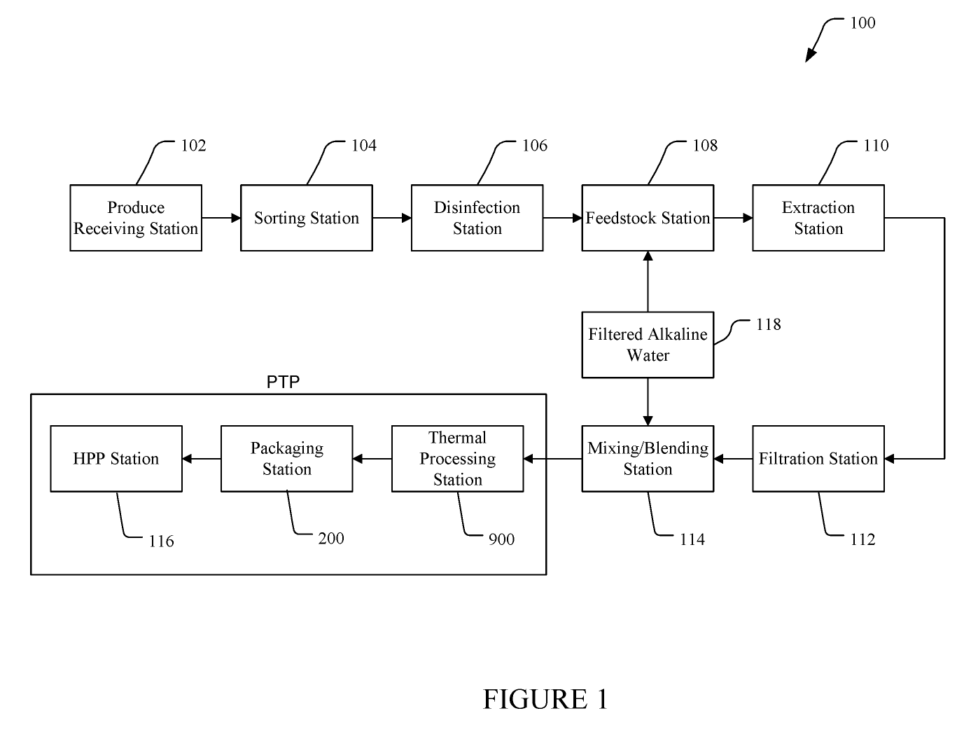

One or more embodiments of the present invention will now be described with references to FIGS. 1-10.

FIG. 1 is an illustration of an exemplary juice extraction process flow 100 for refrigerated goods in accordance with one or more embodiments of the present invention. As illustrated process 100 comprises produce receiving station 102; sorting and trimming station 104; disinfection station 106; feedstock station 108; extraction station 110; filtration station 112; mixing/blending station 114; thermal processing station 900; packaging station 200; and HPP station 116. The steps of process 100 are preferably performed in a refrigerated state.

In one or more embodiments, the receiving and handling station 102 is the initial step and generally involves receiving and maintaining refrigerated goods, e.g. apple and other produce, in the state in which it was received. For instance, refrigerated produce is generally received and maintained at temperatures between about 30° F. and about 38° F. Preferably, refrigerated produce is maintained at a temperature of about 34° F.

In one or more embodiments, the juice extraction assembly feeds the received produce to a sorting station 104 where sorting and trimming of the produce may be performed as needed to ensure the resulting juice meets quality specifications. At sorting station 104, the produce is further prepared depending on the desired flavor profile of the resulting juice. For example, the rind is separated from the meat for Classic watermelon beverage. However, for other watermelon beverages, the whole watermelon, i.e. rind and meat, may be included for juicing.

In one or more embodiments of the present invention, the sorting station 104 feeds the refrigerated produce to a disinfection station 106. The disinfection station is preferably a cold refrigerated environment. During this step, i.e. 106, the produce may be sanitized using known Peracetic acid (PAA) methods. Those of skill in the arts would appreciate that other methods of sanitizing the produce may be employed without deviating from the spirit of the invention.

In one or more embodiments of the present invention, the disinfection station 106 feeds the sorted produce to a feedstock station 108 for weighing, batching and mixing of the produce as needed. Filtered water 118, preferably alkaline, may be added to the produce at feedstock station 108 based on the hydration level of the produce. The weighing and batching step provides a starting estimated produce weight based on expected yield of raw produce for the extracted juice. However, the juice extraction process continues to run with additional feedstock until the expected yield of juice needed for the juice blends is obtained. Preferably, each individual produce is juiced separately and then combined as needed to make juice blends.

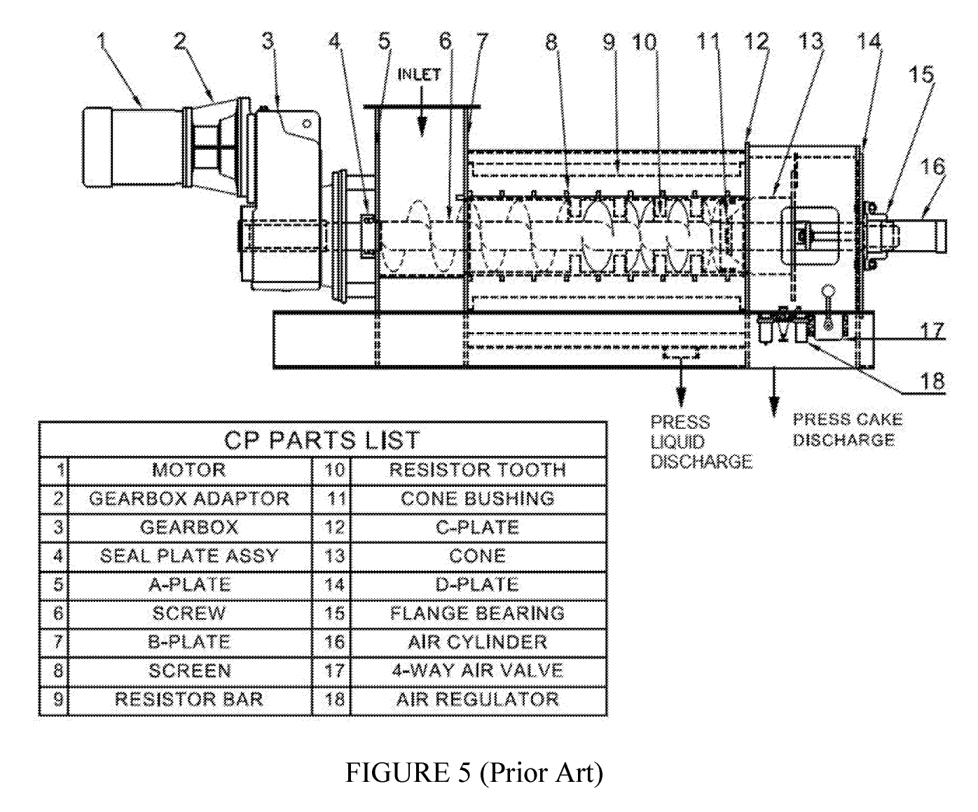

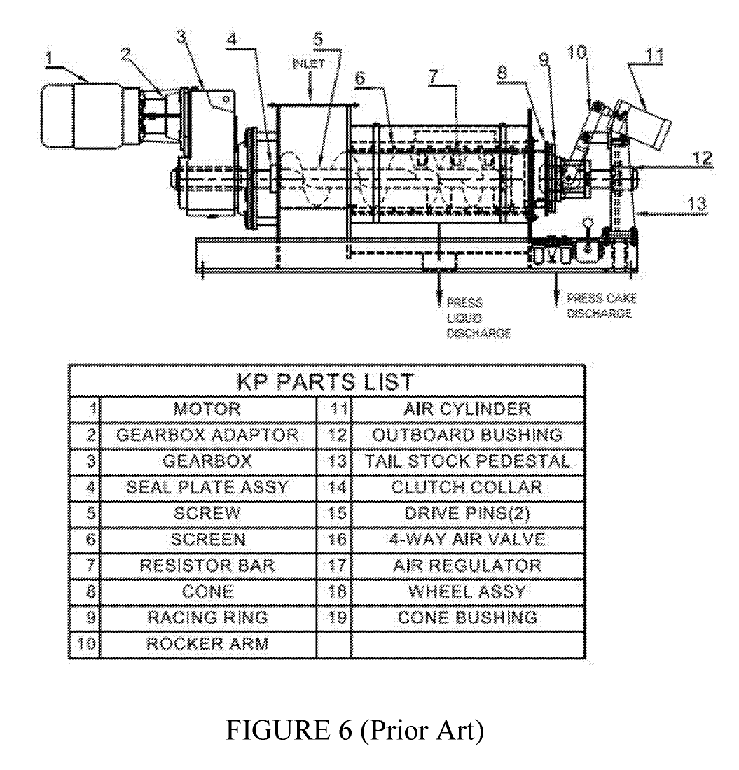

In one or more embodiments of the present invention, the produce from feedstock station 108 feeds into a juice extraction station 110. The juice extraction station is preferably a cold refrigerated environment. The juice extraction station 110 comprises a produce grinder. The produce grinder is preferably a high pressure screw type device, e.g., the CP Series Screw Press (illustrated in FIG. 5) and KP Series Screw Press (illustrated in FIG. 6), both from Vincent Corporation. One or more embodiments of the invention use a stainless steel single screw and twin screw press system with a screen that is sized to substantially separate the juice from the pulp under pressure. The size of the holes on the screen depends on the type of produce being processed. The extraction process 110 is a continuous feed system compared to prior art systems that use a batch accordion style bag press system. It should be obvious to those of skill in the art that other high pressure screw type presses may be employed without deviation from the spirit of the present invention.

In one or more embodiments, the pressure ranges for the screw press varies from about 20 psi to about 100 psi, depending on produce. Speed settings range from about 1800 rpm to about 2880 rpm.

In one or more embodiments of the present invention, the juice extraction station 110 cascades with gravity to a vibratory filtering station 112. The vibratory filtering station uses various size mesh screens to filter the juice using gravity and/or pressure. An exemplary screen for the filtering station may be a SWECO model, for instance. The filtering station employs filtering screens ranging from about 50 mesh (300 micron) to about 300 mesh (50 micron), depending on produce. With these mesh sizes, the filtering station provides a gentle filtering process that minimizes off flavor profiles from high pressure on the juice pulp. Depending on the clarity of the final juice, the juice may also be processed through a mesh sock filter. The mesh sock filtering is preferably with about 150 mesh (100 micron) screens.

In one or more embodiments of the present invention, the filtering station 112 feeds to a mixing/blending station 114. At the mixing/blending station, 114, different juices may be mixed together, mixed with filtered water 118 or with other products, based on a formula. The mixed juices may be filtered again using the apparatus of step 112, tasted and adjusted to match certain flavor profile by adding small amounts of the juices and ingredients as needed. Master Tasters may be used to make final decisions on juice profiles.

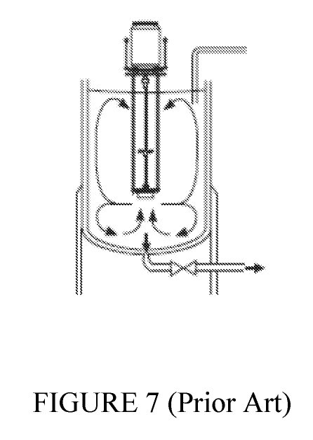

In one or more embodiments of the present invention, the device in the mixing/blending station 114 comprises a batch mixer, illustrated in FIG. 7. The mixing/blending station 114 may employ interchangeable rotor/stator mixing heads to allow for use on a wide variety of different products.

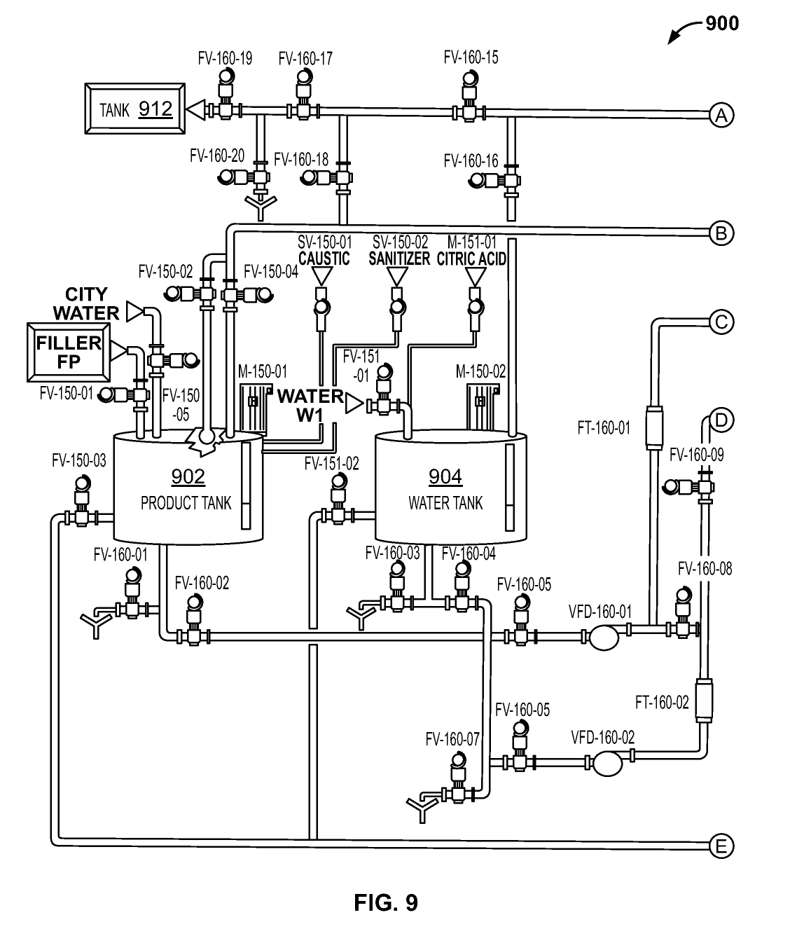

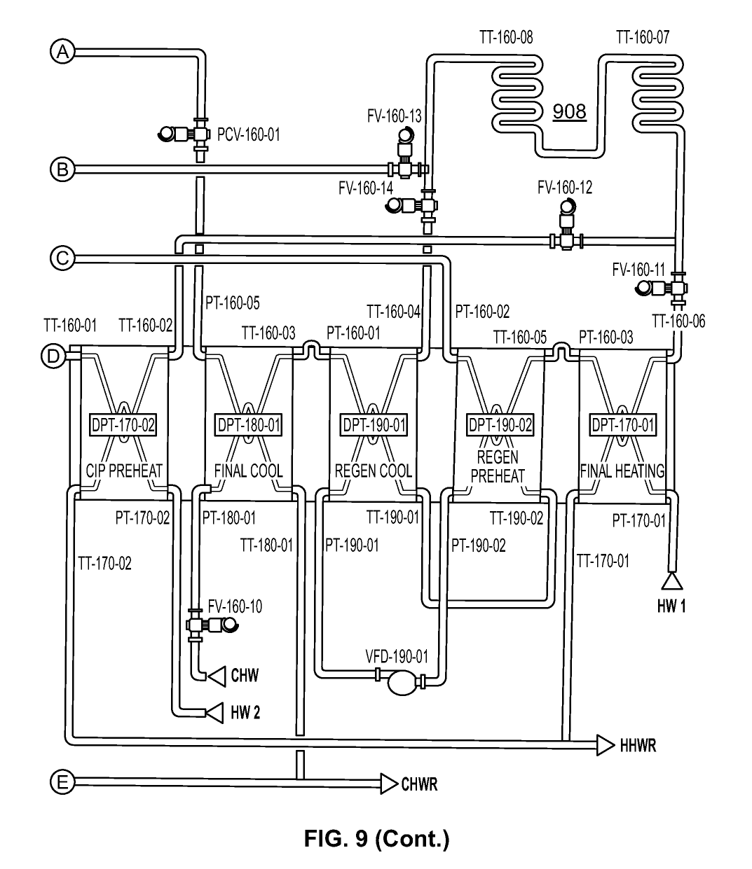

In one or more embodiments of the present invention, the juice (i.e. beverage) product from step 114 feeds to optional thermal processing station 900. Thermal processing station 900 is optional because beverage products with pH <4.6 may not be required to undergo the additional thermal processing, for example. At thermal processing station 900, the pressed beverage product with pH >4.6 undergoes a thermal pasteurization process, described in detail below with respect to FIG. 9.

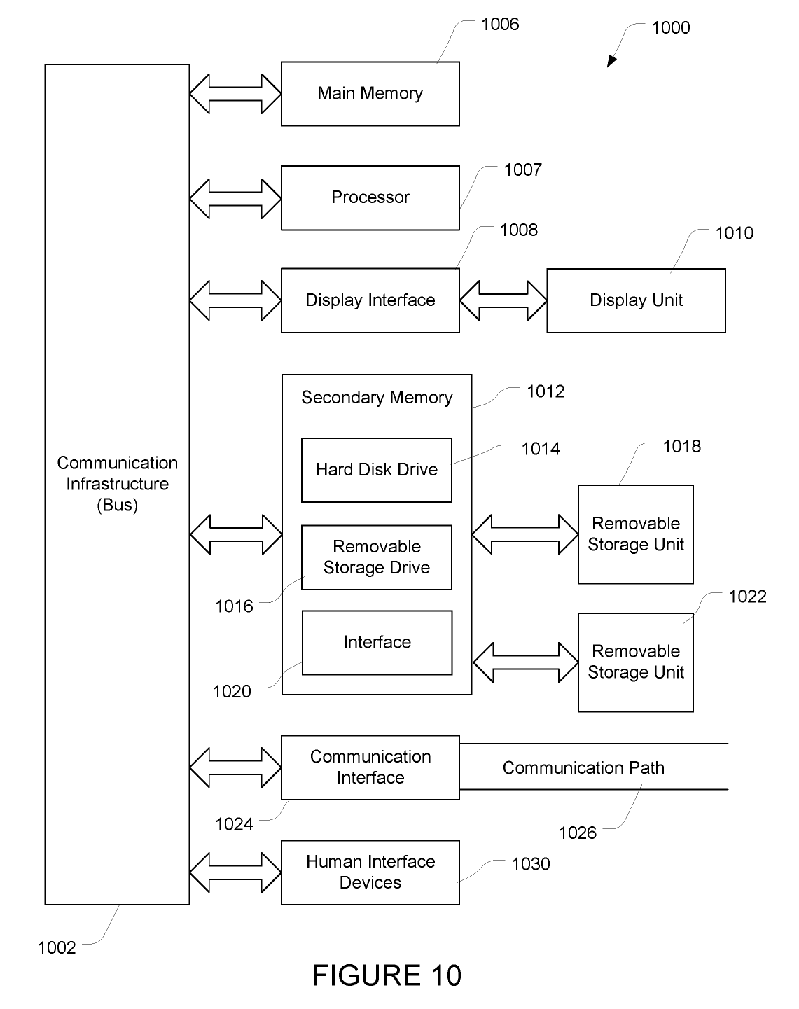

FIG. 9 is an illustration of an exemplary thermal processing component 900 of the Pressed Thermic Pascalization system in accordance with one or more embodiments of the present invention. As illustrated, thermal processing system 900 comprises a Product tank 902; a water tank 904; a heat exchanger DPT-170-02 for CIP (Clean-In-Place) preheat; two heat exchangers DPT-180-01 and DPT-190-01 for cooling the beverage product; two heat exchangers DPT-190-02 and DPT-170-01 for heating the beverage product; a two-part hold tube TT-160-07 and TT-160-08 for holding the heated beverage product at a desired temperature; filler feed tank 912 for holding the thermally pasteurized beverage product; pumps VFD-160-01, VFD-160-02 and VFD-190-01; and a plurality valves FV-XXX-YY and PCV-XXX-YY (where XXX is 150-170; and YY is 1-20). In one or more embodiments, one or more of the valves and pumps are connected to and controlled by a specially programmed computer, e.g. as illustrated in FIG. 10. Those of skill in the art would appreciate that the valves may also be manually operated, without deviating from the invention.

Sterilization of System

The clean-in-place system comprises heat exchanger DPT-170-02 which receives its heating fluid, e.g. hot water HW 2, from a high temperature water reservoir (not shown) which enters at port PT-170-02 and exits at port TT-170-02 to return to the high temperature water reservoir through the high heat water return path, HHWR. The hot water from the reservoir is sufficient to heat the cleaning water being passed through heat exchanger DPT-170-02, which is used for the clean-in-place cycle of the system, to a temperature of approximately 185° F. or greater. The cleaning water, e.g. City Water, from water tank 904 enters heat exchanger DPT-170-02 through a path comprising valves FV-160-04, FV-160-05, FV-160-08, and FV-160-09, into port TT-160-01 and exits at port TT-160-02 and then passes through valve FV-160-12 to the rest of the system to clean it, especially the fluid paths of the beverage product. After the system is cleaned, sterilized water is circulated through the entire system, except CIP heat exchanger DPT-170-02, to maintain sterility prior to use. For instance, the connecting tubes, heat exchangers, tanks, etc., are preferably all circulate on sterilized water while waiting for the beverage product.

In one or more embodiments, the system is sterilized with a proprietary water sterilization process using acidified water, e.g. with Citric Acid, at the same pH level (e.g. >4.6) as the product range to be thermally processed. The system preferably holds the sterilization temperature, e.g. >185° F., for a minimum hold time, e.g. 10 minutes, to meet sterilization requirements. The sterilized system circulates on sterile water while waiting on raw product, i.e. beverage product. When the beverage product is introduced, the system separates from water and processes the beverage product with the system stabilized at the minimum temperature and hold time. The separation from water may be accomplished by opening of the appropriate valves and draining of the water through the corresponding drains.

Thermal Processing

The beverage product from the blending/mixing station is placed in the product tank through Filler Flow Panel FILLER FP, which is coupled to the product receiving tank 902 through valve FV-150-01. Valve FV-150-01 opens or closes depending on the processing cycle, e.g. if beverage product is being processed or if sterilized water is being circulated. The product receiving tank receives the beverage product from the pressing process, which occurs at refrigeration temperatures, thus the pressed beverage product is cold, e.g. about 50° F. The cold beverage product from the pressing process (e.g. steps 110 through 114) could be between 45° F. and 55° F., or between 30° F. and 60° F. Product tank 902 is fluidly coupled to heat exchanger DPT-190-02 through vales FV-160-02, FV-160-05, pump VFD-160-01 and flow meter FT-160-01 into beverage product inlet port PT-160-02 of the of heat exchanger DPT-190-02 for preheating of the beverage product.

Heat exchanger DPT-190-01 and heat exchanger DPT-190-02 are fluidly coupled in a closed loop regeneration circuit through pump VFD-190-01. As illustrated, the pump is fluidly coupled to port PT-190-01 of heat exchanger DPT-190-01 and out through port TT-190-01, into port TT-190-02 of heat exchanger DPT-190-02 and out port PT-190-02 and back to pump VFD-190-01. In this fluid path configuration, the heat extracted from cooling of the heated beverage product from hold tube TT-160-08 (i.e. 908) is reused to preheat cold beverage product from product tank 902 in the heat exchanger DPT-190-02, and the cold temperature extracted from the cold beverage product from the product tank is used to pre-cool the beverage product from the hold tube TT-160-08 (i.e. 908). In one or more embodiments, the fluid in the regeneration circuit flows in a counter current, i.e. opposite, direction as the fluid being processed. Using a counter-current system ensures that the beverage product exiting the heat exchanger is at the highest temperature when heating because it encounters the maximum heat energy of the heating water, in the heat exchanger. Also, counter-current for the cooling cycle ensures that the beverage product exiting the heat exchanger is at the lowest temperature because it encounters the cooling energy of the chilled water at its lowest temperature in the heat exchanger. Note that energy transfer between the media and product in the heat exchangers is by conductivity.

Those of skill in the art would appreciate that the regeneration circuit may not be used in other embodiments of the invention. For example, one or more embodiments may only use one heat exchanger for heating, e.g. DPT-170-01, and one heat exchanger for cooling, e.g. DPT-180-01, thus not requiring the regeneration circuit.

The cold beverage product entering heat exchanger DPT-190-02 through port PT-160-02 is preheated by the regeneration circuit and exits through port TT-160-05 to heat exchanger DPT-170-01 through port PT-160-03, i.e. heat exchangers DPT-190-02 and DPT-170-01 are fluidly coupled through ports TT-160-05 and PT-160-03.

Heat exchanger DPT-170-01 receives its heating fluid, i.e. hot water HW 1, from the high temperature water reservoir (not shown) which enters at port PT-170-01 and exits at port TT-170-01 to return to the high temperature water reservoir through the high heat water return path, HEIWR. The hot water from the reservoir is sufficient to heat the preheated beverage product being passed through heat exchanger DPT-170-01 to a temperature of about 195° F., e.g. a range of between 185° F. and 205° F. In this configuration, the high temperature water in the heat exchanger DPT-170-01 flows in a counter current direction, i.e. opposite, as the beverage product entering the heat exchanger.

Output TT-160-06 of heat exchanger DPT-170-01 is fluidly coupled through valve FV-160-11 to a fluid temperature hold conduit 908, e.g. two-part tube TT-160-07 and TT-160-08, wherein the beverage product is maintained at approximately the temperature it exited the heat exchanger DPT-170-01 for a minimum period of time, e.g. at least 10 minutes, resulting in pasteurization of the beverage product. In one or more embodiments, fluid temperature hold conduit 908, e.g. two-part tube TT-160-07 and TT-160-08, is thermally insulated to retain the beverage product at the kill temperature for the desired hold time. The fluid temperature hold conduit 908 may be configured as one or more coils fluidly coupled together, for example.

Output of fluid temperature hold conduit 908 is fluidly coupled to input TT-160-04 of heat exchanger DPT-190-01 through valve FV-160-14. Heat exchanger DPT-190-01 performs precooling of the beverage product using the regeneration circuit previously discussed.

Output PT-160-01 of heat exchanger DPT-190-01 is fluidly coupled to input TT-160-03 of heat exchanger DPT-180-01. In heat exchanger DPT-180-01, the pasteurized beverage product is further cooled to a desired final cooling temperature for packaging, e.g. about 45° F. or less. The final packaging temperature could range from about 30° F. to about 50° F. In one or more embodiments, the final cooling temperature could be close, e.g. within ±5° F., to the desired refrigeration temperature.

Heat exchanger DPT-180-01 receives its cooling fluid, i.e. chilled water, CHW, from a cold temperature reservoir (not shown), through valve FV-160-10. The chilled water enters the heat exchanger at port PT-180-01 and exits at port TT-180-01 to return to the cold temperature (or chilled) water reservoir through the chilled water return path, CHWR. The chilled water from the reservoir is sufficient to cool the precooled and thermally pasteurized beverage product being passed through heat exchanger DPT-180-01 to the desired packaging temperature. In this fluid path configuration, the chilled water in the heat exchanger DPT-180-01 flows in a counter current, i.e. opposite, direction as the beverage product.

Output PT-160-05 of heat exchanger DPT-180-01 is fluidly coupled through valves PCV-160-01, FV-160-15, FV-160-17, and FV-160-19 to a filler feed tank 912. The thermally pasteurized beverage product at filler feed tank 912 is then processed in packaging station 200.

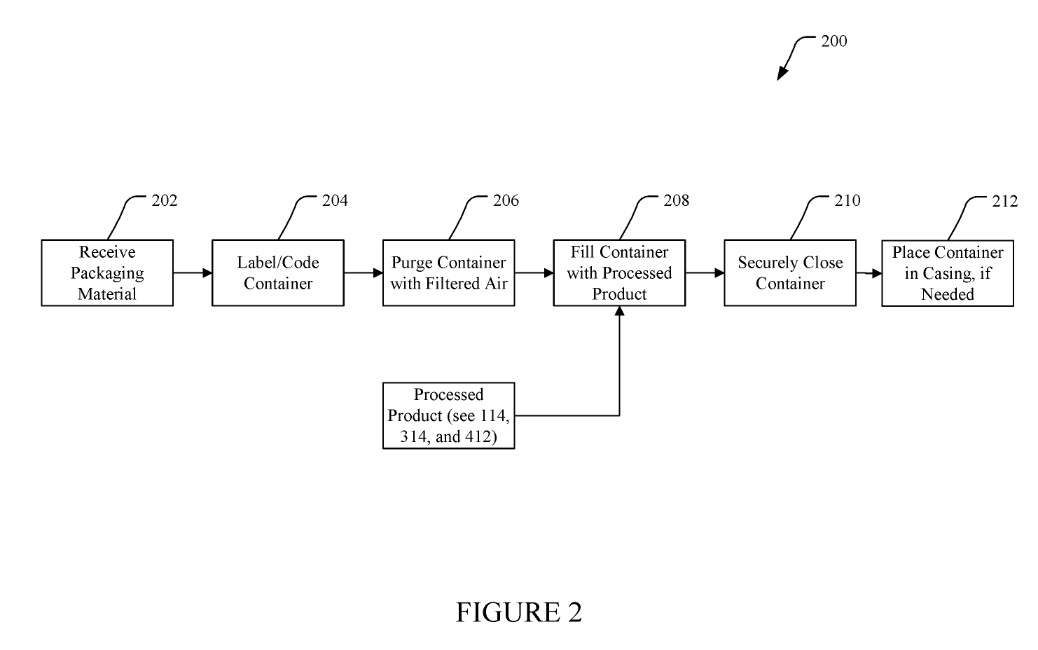

In one or more embodiments, the output of the thermal pasteurization process 900 feeds into a packaging station 200. FIG. 2 is an illustration of an exemplary packaging process 200 in accordance with one or more embodiments of the present invention. As illustrated, packaging process 200 comprises packaging material receiving station 202; labelling and coding station 204; purging station 206; filling station 208; sealing station 210; and an optional casing station 212.

At station 202, the packaging materials are received and stored. In one embodiment, the packaging materials comprise one or more of empty containers, e.g. bottles, bulk bags; labels; cartons; and any other materials needed for packaging of the refrigerated beverage product. The bulk bags may be of the type used in packaging of box wines, for example. The size of the bags may vary, and may depend on the capability of the HPP facility. For instance, the bags may vary in size from 5 gallons to 50 gallons. Those of skill in the arts would appreciate that the above size range for the bulk bags is exemplary and not intended to be limiting since the controlling factor regarding the size may be the capability of the HPP facility.

At station 204, the containers are labelled and or coded and at station 206 the containers may be purged with HEPA (High Efficiency Particle Air) filtered air. At step 208, the containers are filled with the beverage product from the thermal processing station 900, e.g. filler feed tank 912, and sealed in step 210. Thereafter, at step 212 the sealed containers are optionally placed in casings, e.g. boxes, if they are not already in the boxes, for protection and for transfer to an HPP facility or station for high pressure processing.

Referring back to FIG. 1, the casings containing the juice filled and sealed containers, e.g. bulk bags and bottles, may be finally subjected to high pressure processing (HPP) at HPP Station 116. High pressure processing is a 5-log microbiological kill step used to ensure food safety. It is a food processing method wherein the food, already sealed in its final water-resistant packaging, is subjected to very high pressures to inactivate bacteria, yeast and mold present in the raw food. The technology can also be used to enhance desired food attributes in some foods. High pressure processing can improve food safety by inactivating the bacteria that cause food borne illness and spoilage, and parasites that cause diseases. High pressure works like heat to inactivate bacteria, yeast and mold, but the food remains fresh. In a typical process, pre-packaged fresh product is loaded inside a pressure chamber and subjected to very high pressures for specific time. This whole process may take 10 minutes or less.

HPP or pascalization processing is a method of sterilizing prepackaged food, in which a product is processed under very high pressure, leading to the inactivation of certain microorganisms and enzymes in the prepackaged food. HPP is a cold pasteurization technique which consists of subjecting the prepackaged food to a high level of hydrostatic pressure (i.e. pressure transmitted by water) of from 300 MPa/43,500 psi and up to 827 MPa/120,000 psi for a few seconds to a few minutes.

Thereafter, the final packaged and HPP processed containers (e.g. bulk bags, bottles) containing the beverage product may be shipped in refrigerated containers to remote locations around the world for distribution.

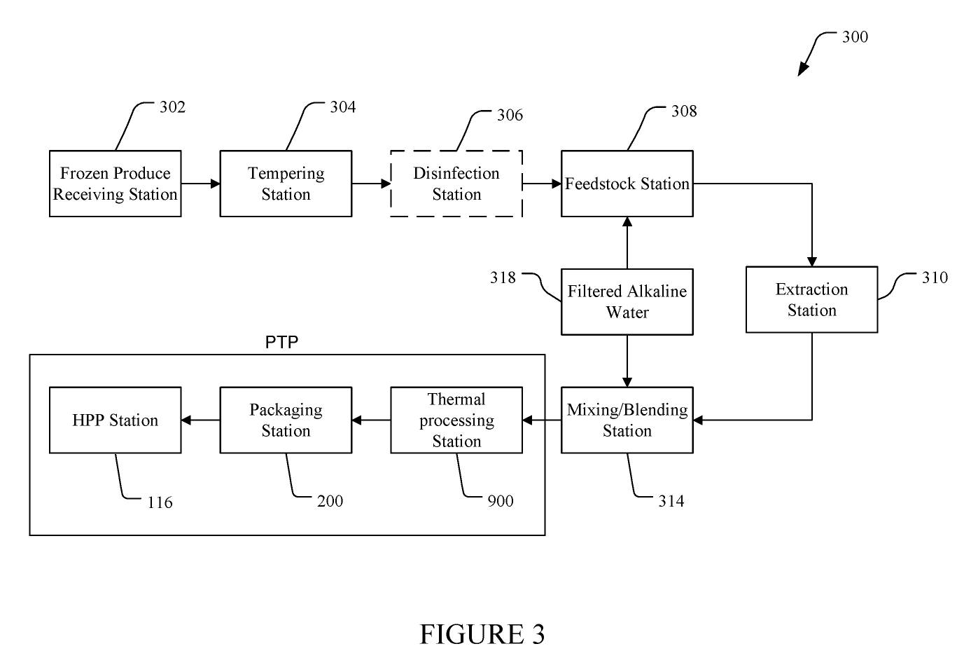

FIG. 3 is an illustration of an exemplary freeze process flow 300 for frozen goods in accordance with one or more embodiments of the present invention. As illustrated process 300 comprises frozen produce receiving station 302; tempering station 304; disinfection station 306; feedstock station 308; mixing/blending station 314; thermal processing station 900; Packaging Station 200; and HPP station 116. The steps of process 300 are preferably performed in a refrigerated state.

In one or more embodiments, the receiving and handling station 302 is the initial step and generally involves receiving and maintaining frozen goods, e.g. coconut juice and meat, mango, banana, peaches, tree nuts, etc., in the frozen state, i.e. state in which it was received. For instance, frozen produce is generally received and maintained at temperatures between −10° F. and +20° F. Preferably, frozen produce is maintained at a temperature of about 0° F.

In one or more embodiments, the juice extraction assembly feeds the received produce to a tempering station 304 where the frozen produce is tempered to refrigerated temperatures, e.g. between about 30° F. and about 50° F.

In one or more embodiments of the present invention, the tempering station 304 feeds the refrigerated produce to optional disinfection station 306. The disinfection station is preferably a cold refrigerated environment. During this step, i.e. 306, the produce may be sanitized using known PAA methods. Those of skill in the arts would appreciate that other methods of sanitizing the produce may be employed without deviating from the spirit of the invention.

In one or more embodiments of the present invention, the disinfection station 306 feeds the sorted produce to a feedstock station 308 for weighing, batching and mixing of the sanitized produce as needed. Filtered water 318, preferably alkaline, may be added to the produce at feedstock station 308 based on the hydration level of the produce. The weighing and batching step provides the estimated produce weight based on expected yield of raw produce for the freeze material.

In one or more embodiments of the present invention, the feedstock station 308 feeds to extraction station 310 wherein juice is extracted from the produce. The extracted juice may be further processed at mixing/blending station 314. At the mixing/blending station, 314, the extracted juice may be mixed together with different ingredients, mixed with filtered water 318 or with other products, based on a formula to create the beverage product.

In one or more embodiments of the present invention, the device in the mixing/blending station 314 comprises a batch mixer, illustrated in FIG. 7. The mixing/blending station 314 may employ interchangeable rotor/stator mixing head to allow for use on a wide variety of different products.

In one or more embodiments of the present invention, the beverage product from step 314 optionally feeds to thermal processing station 900. At thermal processing station 900, the beverage product undergoes a thermal pasteurization process, described in detail above with respect to FIG. 9.

The output of the thermal pasteurization process 900 feeds into a packaging station 200. FIG. 2 is an illustration of an exemplary packaging process 200 in accordance with one or more embodiments of the present invention. As illustrated, packaging process 200 comprises packaging material receiving station 202; labelling and coding station 204; purging station 206; filling station 208; sealing station 210; and an optional casing station 212.

At station 202, the packaging materials are received and stored. In one embodiment, the packaging materials comprise one or more of empty containers, e.g. bottles and bulk bags; labels; cartons; and any other materials needed for packaging of the final freeze product. The bulk bags may be of the type used in packaging of box wines, for example. The size of the containers may vary, and may depend on the capability of the HPP facility. For instance, the bags may vary in size from 5 gallons to 50 gallons. Those of skill in the arts would appreciate that the above size range for the bulk bags is exemplary and not intended to be limiting since the controlling factor regarding the size may be the capability of the HPP facility.

Referring back to FIG. 3, after processing at packaging station 200, the packaged product (e.g. containers or casings containing the bulk bags or bottles) may be finally processed at HPP (i.e. High Pressure Processing) Station 116. Thereafter, the final packaged product, e.g. bulk bags, may be shipped in refrigerated containers to remote locations.

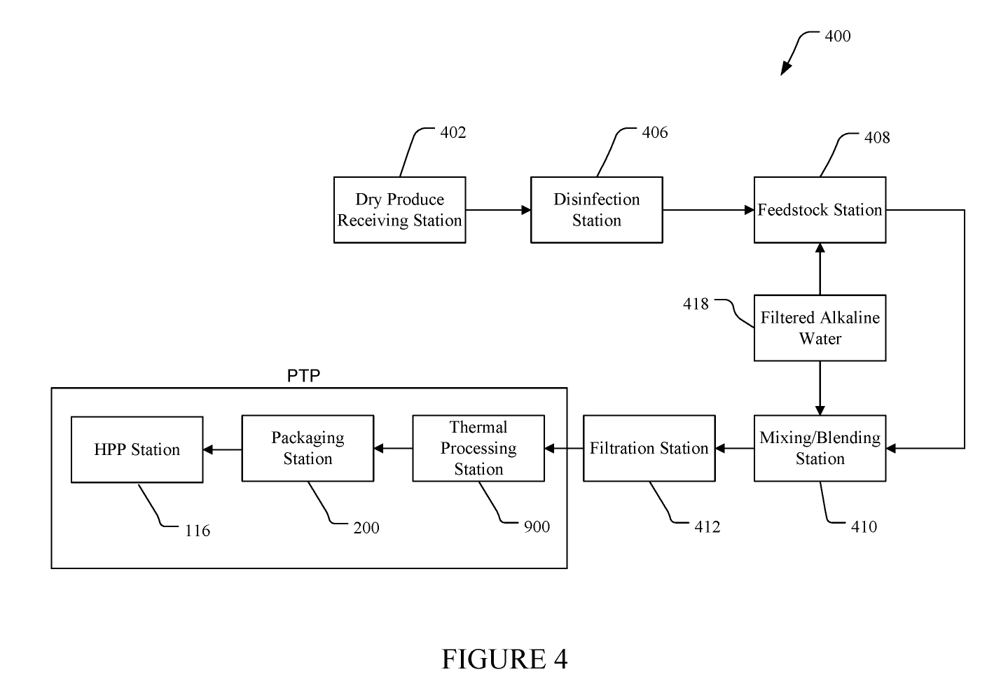

FIG. 4 is an illustration of an exemplary dry goods extraction process 400 in accordance with one or more embodiments of the present invention. As illustrated process 400 comprises dry produce receiving station 402; disinfection station 406; feedstock station 408; mixing/blending station 410; filtration station 412; thermal processing station 900; packaging station 200; and HPP station 116.

In one or more embodiments, the receiving and handling station 402 is the initial step and generally involves receiving and maintaining dry goods, e.g. tree nuts, spices, oils, extracts, and powders, in the state in which it was received. For instance, dry goods are generally received and maintained at temperatures between about 40° F. and about 85° F. Preferably, dry goods are maintained at a temperature of about 55° F. However, in one or more embodiments, nuts and dates are kept refrigerated at temperatures, i.e. between about 30° F. and about 50° F. Preferably, nuts and dates are maintained at a temperature of about 34° F.

In one or more embodiments of the present invention, the received dry goods from station 402 feeds the dry produce to optional disinfection station 406. The disinfection station is preferably a cold refrigerated environment. During this step, i.e. 406, the produce may be sanitized using known PAA methods. Those of skill in the arts would appreciate that other methods of sanitizing the produce may be employed without deviating from the spirit of the invention.

In one or more embodiments of the present invention, the sanitized dry goods from station 406 feeds to a feedstock station 408 for weighing, batching and mixing of the produce as needed. Filtered water 418, preferably alkaline, may be added to the produce at feedstock station 408 based on the hydration level of the produce. The weighing and batching step provides the estimated produce weight based on expected yield for the toppings.

In one or more embodiments of the present invention, the feedstock station 408 feeds to a mixing/blending station 410. The mixing/blending station uses a specially designed nut processing skid, blend system. At the mixing/blending station 410, water may be added to the dry goods, e.g. raw nuts and dates, the mixture is disintegrated and fed to filtering station 412. The water is preferably filtered alkaline water 418. However, it should be emphasized that the nuts are not soaked, as in the prior art, because soaking may result in loss of flavor from the oils. Also, at step 410, additional ingredients may be added to complete the blend. Thus, at the mixing/blending station, 410, different dry goods may be mixed together, mixed with filtered water 418 or with other products, based on a formula to generate the desired blend for the beverage product.

In one or more embodiments of the present invention, the device in the mixing/blending station 410 comprises a batch mixer, illustrated in FIG. 7. The mixing/blending station 410 may employ special interchangeable rotor/stator mixing heads to allow for use on a wide variety of different products.

In one or more embodiments of the present invention, the mixing/blending station 410 may be cascaded with a vibratory filtering station 412. The vibratory filtering station may use various size mesh screens to filter the toppings using gravity and/or pressure. An exemplary screen for the filtering station may be a SWECO model, for instance. The filtering station may employ single or dual screen filters ranging from about 50 mesh (300 micron) to about 300 mesh (50 micron), depending on produce. In one or more embodiments, the screens may be cascaded to achieve the desired filtering clarity. In addition to the filtering with the SWECO process, a mesh sock filter may also be employed.

In one or more embodiments of the present invention, the beverage product from step 412 optionally feeds to thermal processing station 900. At thermal processing station 900, the beverage product undergoes a thermal pasteurization process, described in detail above with respect to FIG. 9.

The output of the thermal pasteurization process feeds into a packaging station 200. FIG. 2 is an illustration of an exemplary packaging process 200 in accordance with one or more embodiments of the present invention. As illustrated, packaging process 200 comprises packaging material receiving station 202; labelling and coding station 204; purging station 206; filling station 208; sealing station 210; and an optional casing station 212.

At station 202, the packaging materials are received and stored. In one embodiment, the packaging materials comprise one or more of empty containers, e.g. bottles and bulk bags; labels; cartons; and any other materials needed for packaging of the final freeze product. The bulk bags may be of the type used in packaging of box wines, for example. The size of the containers may vary, and may depend on the capability of the HPP facility. For instance, the bags may vary in size from 5 gallons to 50 gallons. Those of skill in the arts would appreciate that the above size range for the bulk bags is exemplary and not intended to be limiting since the controlling factor regarding the size may be the capability of the HPP facility.

Referring back to FIG. 4, after processing at packaging station 200, the casings containing the secured bulk bags may be finally processed at HPP (i.e. High Pressure Processing) Station 116. Thereafter, the final packaged product, e.g. bulk bags, may be shipped in refrigerated containers to remote locations.

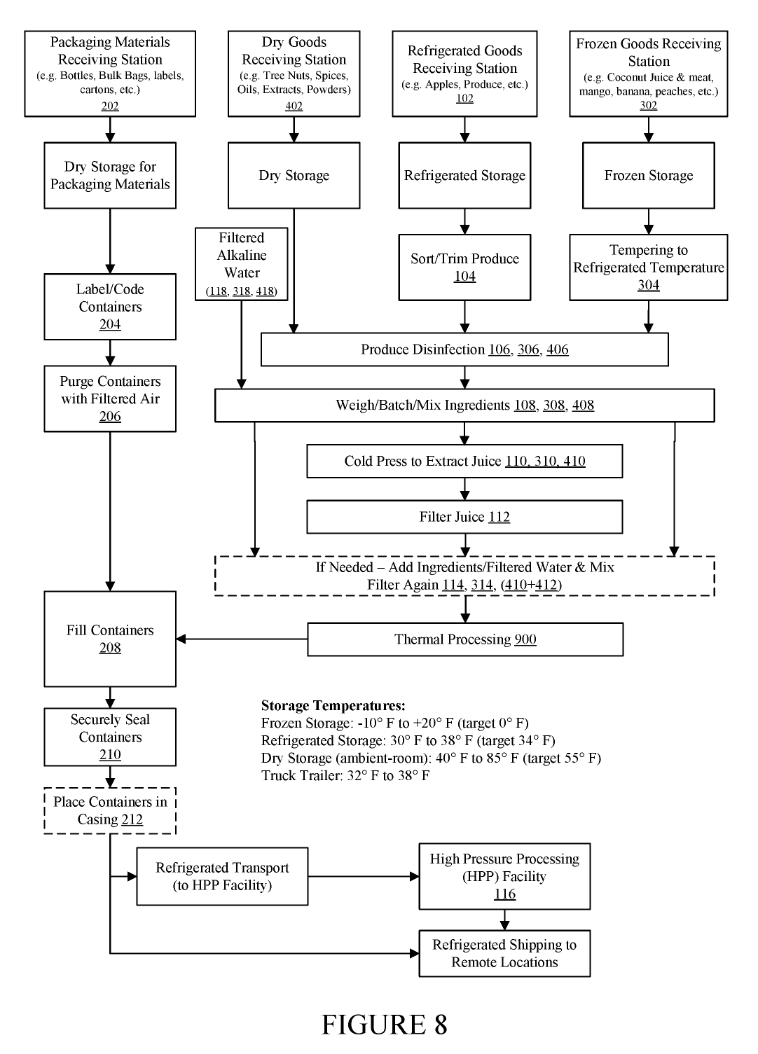

In one or more embodiments, the juice extraction process flow 100 for refrigerated goods, the freeze process flow 300 for frozen goods, the dry goods extraction process 400, or combinations thereof, may be coupled together to provide a hybrid produce processing system as illustrated in FIG. 8. As illustrated, the different embodiments of the present invention may further comprise bottling at remote location.

FIG. 10 diagrams a general-purpose computer and peripherals, when programmed as described herein, may operate as a specially programmed computer capable of implementing one or more methods, apparatus and/or systems of the solution described in this disclosure. Processor 1007 may be coupled to bi-directional communication infrastructure 1002 such as communication infrastructure system bus 1002. Communication infrastructure 1002 may generally be a system bus that provides an interface to the other components in the general-purpose computer system such as processor 1007, main memory 1006, display interface 1008, secondary memory 1012 and/or communication interface 1024.

Main memory 1006 may provide a computer readable medium for accessing and executed stored data and applications. Display interface 1008 may communicate with display unit 1010 that may be utilized to display outputs to the user of the specially-programmed computer system. Display unit 1010 may comprise one or more monitors that may visually depict aspects of the computer program to the user. Main memory 1006 and display interface 1008 may be coupled to communication infrastructure 1002, which may serve as the interface point to secondary memory 1012 and communication interface 1024. Secondary memory 1012 may provide additional memory resources beyond main memory 1006, and may generally function as a storage location for computer programs to be executed by processor 1007. Either fixed or removable computer-readable media may serve as Secondary memory 1012. Secondary memory 1012 may comprise, for example, hard disk 1014 and removable storage drive 1016 that may have an associated removable storage unit 1018. There may be multiple sources of secondary memory 1012 and systems implementing the solutions described in this disclosure may be configured as needed to support the data storage requirements of the user and the methods described herein. Secondary memory 1012 may also comprise interface 1020 that serves as an interface point to additional storage such as removable storage unit 1022. Numerous types of data storage devices may serve as repositories for data utilized by the specially programmed computer system. For example, magnetic, optical or magnetic-optical storage systems, or any other available mass storage technology that provides a repository for digital information may be used.

Communication interface 1024 may be coupled to communication infrastructure 1002 and may serve as a conduit for data destined for or received from communication path 1026. A network interface card (NIC) is an example of the type of device that once coupled to communication infrastructure 1002 may provide a mechanism for transporting data to communication path 1026. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 1026 may comprise any type of telecommunication network or interconnection fabric that can transport data to and from communication interface 1024.

To facilitate user interaction with the specially programmed computer system, one or more human interface devices (HID) 1030 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 1007 to trigger one or more responses from the specially programmed computer are within the scope of the system disclosed herein.

While FIG. 10 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 10.

While the invention herein disclosed has been described by means of specific embodiments and applications thereof, numerous modifications and variations could be made thereto by those skilled in the art without departing from the scope of the invention set forth in the claims.

What is claimed is:

1. A system for destroying C. Botulinum spores while maintaining product integrity of ready to drink beverages:
a product receiving tank for receiving ready-to-drink beverage with a pH >4.6, the beverage comprising cold pressed fruit/vegetable juices or nut milks;
a first heat exchanger fluidly coupled to the receiving tank for heating the beverage to a kill temperature of about 195° F. using a closed loop counter current process;
one or more hold tubes fluidly coupled to an output of the first heat exchanger for holding the heated beverage at approximately the kill temperature for a hold time of at least 10 minutes resulting in thermally pasteurized beverage;
a second heat exchanger fluidly coupled to the one or more hold tubes for cooling the thermally pasteurized beverage down to a packaging temperature of about 45° F. in using a closed loop counter current process;
a filler feed tank fluidly coupled to the second heat exchanger for receiving the cooled beverage;
a packaging station for filling and sealing the cooled beverage from the feed tank into a distribution container; and
a HPP station for subjecting the filled and sealed distribution container to high pressure processing.

2. The system of claim 1, wherein said first heat exchanger comprises a preheat and a final heating station.

3. The system of claim 1, wherein the counter current for the first heat exchanger is provided from a hot temperature reservoir.

4. The system of claim 1, wherein said second heat exchanger comprises a pre-cool and a final cooling station.

5. The system of claim 1, wherein the counter current for the second heat exchanger is provided from a cold temperature reservoir.

6. The system of claim 1, further comprising a pump fluidly coupled between the receiving tank and the first heat exchanger.

7. The system of claim 1, wherein the packaging station is refrigerated.

8. A system for destroying C. Botulinum spores while maintaining product integrity of ready to drink beverages:
a product receiving tank for receiving ready-to-drink beverage;
a first heat exchanger fluidly coupled to the receiving tank for heating the beverage to a kill temperature using a closed loop counter current process;
one or more hold tubes fluidly coupled to an output of the first heat exchanger for holding the heated beverage at approximately the kill temperature for a hold time resulting in thermally pasteurized beverage;
a second heat exchanger fluidly coupled to the one or more hold tubes for cooling the thermally pasteurized beverage down to a packaging temperature in using a closed loop counter current process;
a filler feed tank fluidly coupled to the second heat exchanger for receiving the cooled beverage;
a packaging station for filling and sealing the cooled beverage from the feed tank into a distribution container; and
a HPP station for subjecting the filled and sealed distribution container to high pressure processing.

9. The system of claim 8, wherein the ready-to-drink beverage comprises cold pressed fruit/vegetable juices or nut milks.

10. The system of claim 8, wherein the ready-to-drink beverage has a pH >4.6.

11. The system of claim 8, wherein the kill temperature is between 185° F. and 205° F.

12. The system of claim 8, wherein the hold time is at least 10 minutes.

13. The system of claim 8, wherein the packaging temperature is about 45° F. or less.

14. The system of claim 8, wherein the packaging station is refrigerated.

15. A method for destroying C. Botulinum spores while maintaining integrity of ready to drink beverages:
receiving ready to drink beverage with pH >4.6;
heating the beverage to a kill temperature of between 185° F. and 205° F. in a first heat exchanger, using a closed loop counter current process;
transferring the heated beverage to a hold tube and maintaining the heated beverage in the hold tube at approximately the kill temperature for a hold time of at least 10 minutes resulting in thermally pasteurized beverage;
cooling the thermally pasteurized beverage down to a packaging temperature of about 45° F. in a second heat exchanger, using a closed loop counter current process;
transferring the cooled beverage from the second heat exchanger to a filler feed tank;
filling and sealing the cooled beverage from the feed tank into a distribution container; and
subjecting the filled and sealed distribution container to high pressure processing (HPP).

16. The method of claim 15, wherein the distribution container is a bulk bag or bottle.

17. The method of claim 15, wherein the ready-to-drink beverage comprises cold pressed fruit/vegetable juices or nut milks.

18. The method of claim 15, wherein the kill temperature is about 195° F.
